(19) United States
(12) Patent Application Publication
(10) Pub. No.: US 2013/0326575 A1
(43) Pub. Date: Dec. 5, 2013

(54) Social Media Driven Generation of a Highlight Clip from a Media Content Stream

(71) Applicants: Brian Robillard, N. Hollywood, CA (US); Michael Peterson, Woodland Hills, CA (US); Jason Byers, Sherman Oaks, CA (US)

(72) Inventors: Brian Robillard, N. Hollywood, CA (US); Michael Peterson, Woodland Hills, CA (US); Jason Byers, Sherman Oaks, CA (US)

(73) Assignee: DISNEY ENTERPRISE, INC., Burbank, CA (US)

(21) Appl. No.: 13/483,953

(22) Filed: May 30, 2012

(51) Int. Cl. H04N 21/60

(52) U.S. Cl. 725/116; 725/109

(57) ABSTRACT

There is provided a method and system for creating a highlight clip from a media content stream. The method comprises, receiving data corresponding to social media traffic related to a playout of the media content stream, identifying one or more highlight portions of the media content stream using the social media traffic data, selecting one or more media clips corresponding to the one or more highlight portions from a media content database, and generating the highlight clip using the one or more media clips. The social media traffic data may include microblogging traffic relative to the playout of the media content stream, which may take form of an audio-visual, video, or audio stream.

### BACKGROUND

Social networking has revolutionized the way that people interact with each other. From being able to share daily activities and interests, to updating the world on events in real-time, people use social media to share their messages with the world. Social networking media has focused on providing short statements and updates instead of long journal-like entries. This enhances user accessibility and interest by providing quick bursts of information. Often, social media comes in the form of short media clips that a user may view conveniently using a portable device. Such media clips may consist of highlight segments of news, sports, television shows, or other media. Users may prefer these types of highlights when providing or viewing social media because they typically provide quick reference to interesting, humorous, or otherwise notable content.

At present, users may have to create a highlight of a desired portion of media content themselves. This can be time consuming or difficult and often will lead to users foregoing use of a desired segment of the media content. Alternatively, users may have to search to find a highlight that is provided by another party, such as a media content producer. However, without knowing what users want to see, the media content producer may create a suboptimal highlight. For example, it may be difficult the media content producer to identify those portions of media content that are likely to be most desirable to an audience.

### SUMMARY

The present disclosure is directed to social media driven generation of a highlight clip from a media content stream, substantially as shown in and/or described in connection with at least one of the figures, and as set forth more completely in the claims.

### BRIEF DESCRIPTION OF THE DRAWINGS

FIG. 1 presents a block diagram showing an exemplary system for generating a highlight clip from a media content stream;

FIG. 2 shows a more detailed example of one implementation of a media server for use in generating a highlight clip from a media content stream;

FIG. 3 presents an exemplary line graph of social media traffic data during playout of a media content stream; and

FIG. 4 presents a flowchart presenting an exemplary method for generating a highlight clip from a media content stream, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

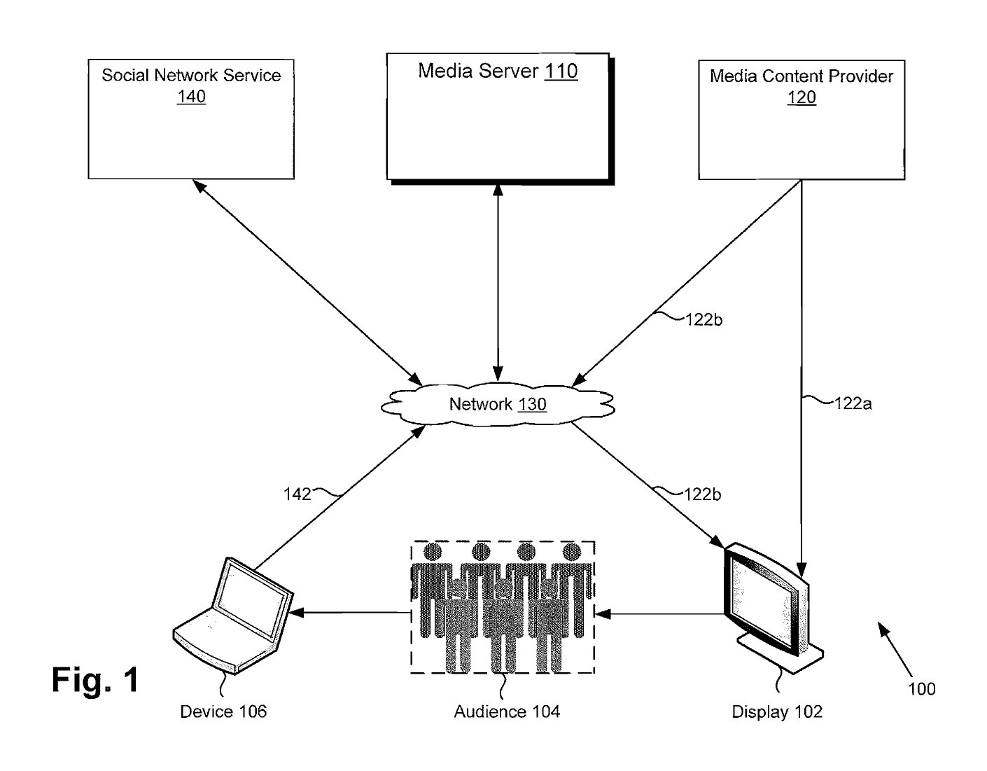

FIG. 1 shows a diagram of one exemplary implementation of a system for generating a highlight clip from a media content stream. As shown in FIG. 1, system environment 100 includes media server 110 accessible over communication network 130 and configured to generate a highlight clip from a media content stream provided by media content provider 120. Also shown in FIG. 1 are display 102, audience 104, communication device 106, and social network service 140.

According to the implementation of FIG. 1, media content provider 120 may provide media content stream 122a and/or 122b, such as a linear program stream or channel, for example, for output on display 102 to audience 104. Media content provider 120 may be a media content provider such as a television or radio network, providing media content, such as an audio-visual, video, or audio stream, for example. More generally, as more media content becomes available, media content provider 120 may be any producer of media content, such as a user generated content provider or new source provider, for example. Therefore, and as shown in FIG. 1, media content provider 120 may utilize communication network 130 to provide media content stream 122b to display 102, or may otherwise provide content to display 102, such as through provision of media content stream 122a via cable or satellite television, or radio airwaves, for example.

A plurality of persons may make up audience 104, who may consume media content stream 122a/122b provided by media content provider 120 through display 102. For example, audience 104 may view a television program provided by media content provider 120 through a television. Although in the implementation of FIG. 1, display 102 is shown as a screen display, display 102 may be any suitable means for outputting the media content, such as a television, a radio, a computer display, a mobile telephone, or a gaining console, for example.

During consumption of media content stream 122a/122b, audience 104 may utilize communication device 106 to engage in social networking utilizing network 130 and social network service 140 by transmitting social media traffic 142 to network 130. Although in the implementation of FIG. 1, communication device 106 is shown as a laptop computer, communication device 106 may be any suitable means for accessing social network service 140, such as a mobile phone, a personal computer (PC) or other home computer, a personal digital assistant (PDA), or a gaming console, for example. Social network service 140 may retain and track data corresponding to social media traffic 142 of audience 104. Moreover, although the implementation of FIG. 1 depicts audience 104 as a collective audience for the purposes of conceptual clarity, no such characterization of audience 104 is intended. For example, audience 104 may include a plurality of persons who are substantially isolated from one another, each consuming media content stream 122a/122b provided by media content provider 120 on an individual display device corresponding to display 102 and each engaging in social networking through the use of a personal communication device corresponding to communication device 106.

In the implementation of FIG. 1, media server 110 may correspond to a dedicated network media server that may access network 130. More generally, media server 110 may be any suitable means for accessing network 130. Media server 110 may connect to network 130 and receive data from social network service 140. Further, media server 110 may also connect to network 130 and access media content stream 122a/122b provided by media content provider 120. Although in the implementation of FIG. 1, media server 110, media content provider 120, and social network service 140, are shown to exist as distinct network entities, it is understood that two or more of media server 110, media content provider 120, and social network service 140 may be included in a single network entity, such as media server 110.

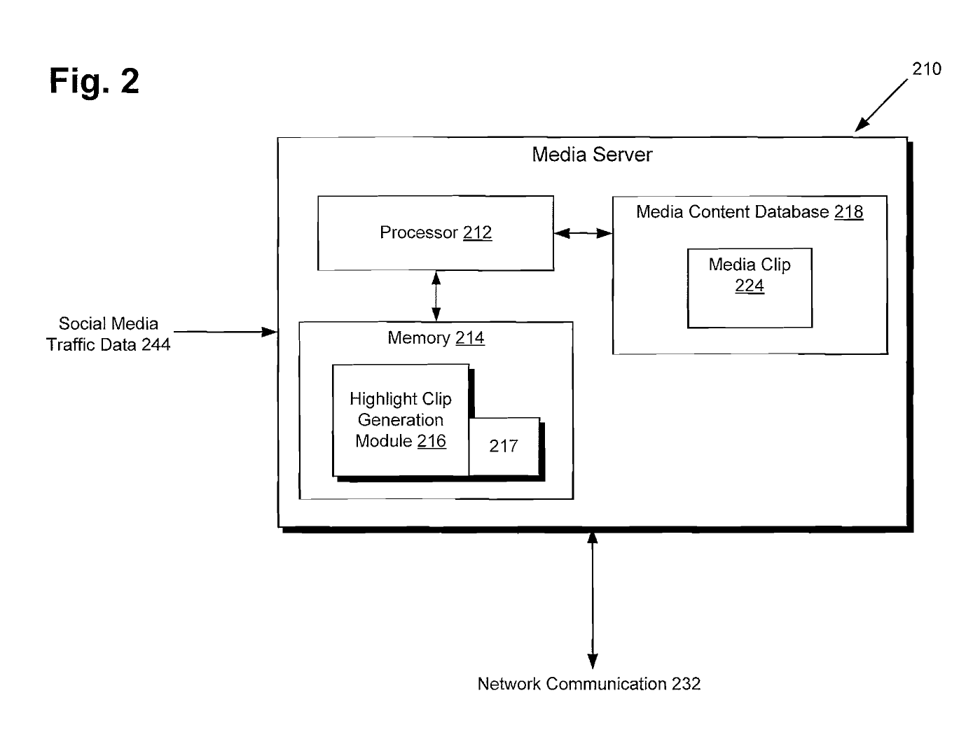

Turning now to FIG. 2, FIG. 2 provides a more detailed representation of one implementation of a media server for use in generating a highlight clip from a media content stream. As shown in FIG. 2, media server 210 includes hardware processor 212, non-transitory storage memory 214, and media content database 218. Also shown in FIG. 2 are highlight clip generation module 216 and highlight clip 217 stored in memory 214, and media clip 224 stored in media content database 218. Media content server 210 having processor 212, memory 214 including highlight clip generation module 216 and highlight clip 217, and media content database 218 including media clip 224, corresponds to media content server 110, in FIG. 1. It is noted that media clip 224 is representative of one or more media clips stored in media content database 218. Consequently, reference to media clip 224 herein is to be interpreted as referring to at least one clip, and perhaps a plurality of media clips associated with a media content stream, such as media content stream 122a/122b.

As further show in FIG. 2, media server 210 may receive social media traffic data 244 from social network service 140 of FIG. 1. For example, and as depicted in FIG. 2, media server 210 may receive social media traffic data 244 from a social network service corresponding to social network service 140, in FIG. 1, or in some implementations, media server 210 may receive social media traffic data 244 over network communication link 232 from a communication network corresponding to communication network 130.

According to the implementation of FIG. 2, processor 212 of media server 210 may access memory 214 containing highlight clip generation module 216. Processor 212 may be configured to run highlight clip generation module 216 to identify a highlight portion of a media content stream corresponding to media content stream 122a/122b, in FIG. 1, using social media traffic data 244. Processor 212 may be further configured to access media content database 218 and select media clip 224 corresponding to the identified highlight portion of media content stream 122a/122b. Highlight clip generation module 216, under the control of processor 212, may be configured to generate highlight clip 217 from media content stream 122a/122b using media clip 224. Although in the implementation of FIG. 2, media content database 218 is shown as contained within media server 210, it is noted that in some implementations, media content database 218 may be accessible by media server 210 but located elsewhere.

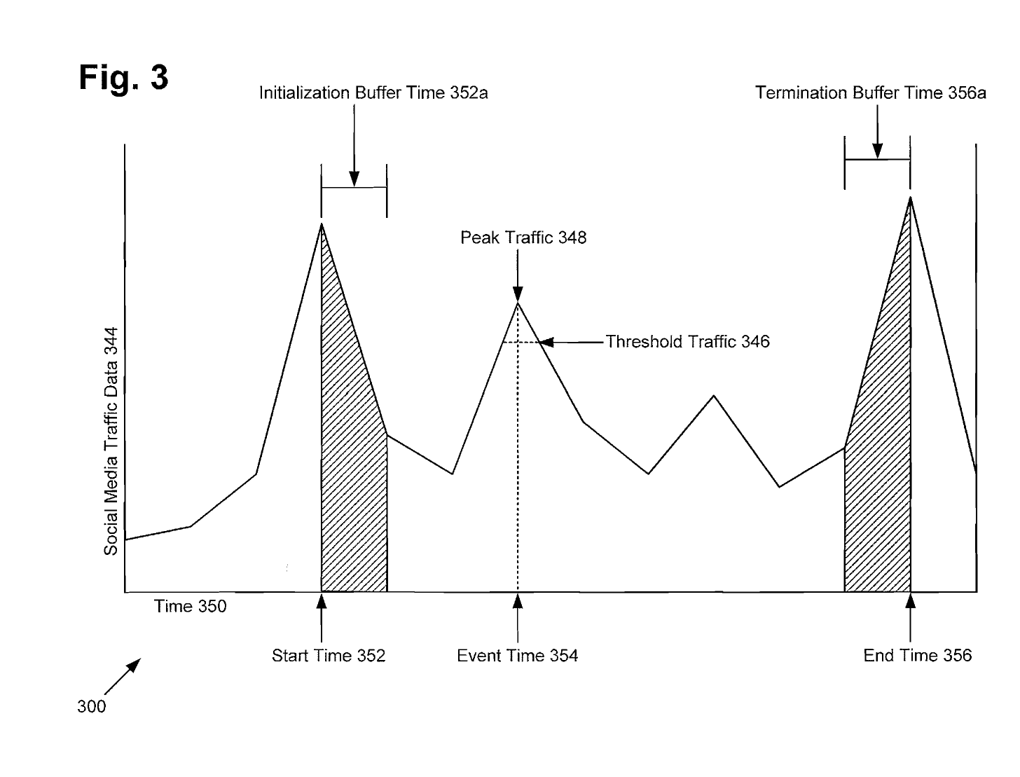

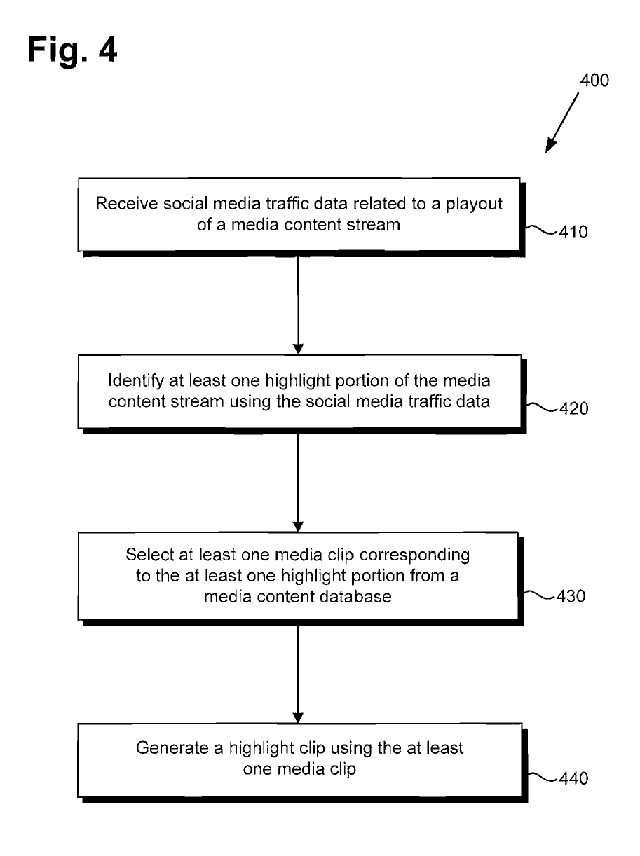

Referring now to FIG. 3, FIG. 3 presents graph 300 of social media traffic data 344 over time 350. As shown in FIG. 3, a media content stream corresponding to media content stream 122a/122b, in FIG. 1, may begin at start time 352, include event time 354, and terminate at end time 356. There may be initialization buffer time 352a corresponding to start time 352 and termination buffer time 356a corresponding to end time 356. During playout of the media content stream from start time 352 to end time 356, there may be threshold traffic 346 and peak traffic 348 in social media traffic data 344. FIG. 3 will be further explained in conjunction with FIG. 4.

FIGS. 1, 2, and 3 will now be further described by reference to FIG. 4, which presents flowchart 400 describing an exemplary method for generating a highlight clip from a media content stream. With respect to the method outlined in FIG. 4, it is noted that certain details and features have been left out of flowchart 400 in order not to obscure the discussion of the inventive features in the present application.

Referring to FIG. 4 in combination with FIG. 1, FIG. 2, and FIG. 3, flowchart 400 begins with receiving social media traffic data 244 related to a playout of a media content stream 122a/122b (410). The receiving may correspond to media server 110/210 utilizing highlight clip generation module 216 under the control of processor 212 to receive social media traffic data 244 corresponding to social media traffic 142 from social network service 140, in FIG. 1. Media content stream 122a/122b may correspond to an audio-visual, video, or audio stream. For example, in one implementation, media content stream 122a/122b may correspond to a video stream. In another exemplary implementation, media content stream 122a/122b may correspond to an audio stream.

Flowchart 400 continues by identifying at least one highlight portion of media content stream 122a/122b using social media traffic data 244 (420). The identifying may be performed by highlight clip generation module 216 of media server 210, under the control of processor 212. Social media traffic data 244 may correspond to social media traffic volume, the presence of a keyword, keywords in the social media traffic, or other social media traffic measurables. For example, in one implementation, social network service 140 may correspond to a microblogging service such as Twitter™. In that implementation, social media traffic 142 may take the form of microblogging traffic, and social media traffic data 244 may be microblogging traffic data, such as data corresponding to microblogging traffic volume or the detection of one or more keywords within microblogging traffic, for example.

Keyword usage may include words corresponding to media content, persons, scenes, or talent associated with media content stream 122a/122b, or other identifying words. In addition to microblogging traffic on a social media service such as Twitter™, social media traffic data 244 may correspond to any of a variety of social networking activities, such as network mediated interactions on social networking services such as Myspace™, Facebook™, or Google+™, for example.

Identifying a highlight portion of media content stream 122a/122b may correspond to detection of social media traffic in excess of threshold traffic 346, or to identification of a portion of media content stream associated with peak traffic 348, occurring at event time 354, in FIG. 3. Social media traffic data 344 may exceed threshold traffic 346 between start time 352 and end time 356 at or around event time 354. Therefore, if social media traffic data 344 meets threshold traffic 348, the identifying may correspond to identifying a highlight portion of media content stream 122a/122b, in FIG. 1, at or around the point at which social media traffic 344 exceeds threshold traffic 346.

Alternatively, the identifying may correspond to peak traffic 348, in FIG. 3. Social media traffic data 344 may reach peak traffic 348 between start time 352 and end time 356 at or around event time 354. Therefore the identifying may correspond to identifying a highlight portion of media content stream 122a/122b, in FIG. 1, at or around peak traffic 348. It is noted that although FIG. 3 shows a single instance of event time 354, there may be more than one event time corresponding respectively to more than one highlight portion of media content stream 122a/122b. That is to say, social media traffic data 344 may exceed threshold traffic 346 at multiple locations and may exhibit multiple instances of peak traffic 348.

Referring to initialization buffer time 352a and termination buffer time 356a. During these intervals, the identifying process may be configured to disregard social media traffic data 344. In this way, the identifying may filter out social media traffic data 344 produced at or around start time 352 and/or end time 356, by choosing to not identify highlight portions during initialization buffer time 352a and termination buffer time 356a. Alternatively, the identifying may be configured not to implement one or both of initialization buffer time 352a and termination buffer time 356a, in which case start time 352 and/or end time 356 might be identified as event times corresponding to highlight portions of media content stream 122a/122b.

The method of flowchart 400 continues by selecting at least one media clip 224 corresponding to the at least one highlight portion from media content database 218 (430). The selecting may be performed by highlight clip generation module 216 of media server 210, under the control of processor 212, and may include selection of one or more media clips corresponding to media clip 224 from media content database 218. Media clip 224 may correspond to one or more audio-visual, video, or audio clip(s) associated with media content stream 122a/122b. For example, in one implementation, media content stream 122a/122b may correspond to a video stream. In that implementation, media clip 224 may take the form of a video clip corresponding to the video stream, for example. In another exemplary implementation, media content stream 122a/122b may correspond to an audio stream. In that implementation, media clip 224 may take the form of an audio clip corresponding to the audio stream, for example.

In one implementation of the method described by flowchart 400, one or more media clip(s) 224 may be edited as part of the selection process (430). For example, media clip(s) 224 may be edited to adapt the length of media clip 224 to correspond to the highlight portion of media content stream 122a/122b, as identified using social media traffic data 244. The editing may be an automated process under the control of an editing program configured to determine the desired start point and end point corresponding to the highlight portion of media content stream 122a/122b, or may be a manual process performed by a human editor, for example. Other processes, such as voice, object, or scene recognition programs, may be introduced into the selecting as well.

Flowchart 400 continues with generating highlight clip 217 using media clip 224 (440). Generation of the highlight clip may be performed by highlight clip generation module 216 of media server 210, under the control of processor 212, and may include generation of highlight clip 217 from one or more media clip(s) 224. Highlight clip 217 may include one media clip or a plurality of media clips. Media server 210 may store highlight clip 217 in memory 214 as shown in FIG. 2, or may transmit highlight clip 217 over network communication link 232. In the implementation of FIG. 1, media server 110 may transmit a highlight clip corresponding to highlight clip 217 over network 130 to media content provider 120, social network service 140, or for output on display 102 to audience 104.

In this manner, a highlight clip may be created based on social media traffic corresponding to audience interest in the media content. Therefore, a media content producer may further enhance audience interaction and media content dissemination by providing desirable highlight clips of media content.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the spirit and the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A method for use by a system having a memory and a processor for creating a highlight clip from a media content stream, the method comprising:
receiving social media traffic data related to a playout of the media content stream;
identifying, using the processor, at least one highlight portion of the media content stream using the social media traffic data;
selecting, using the processor, at least one media clip corresponding to the at least one highlight portion from a media content database;
generating, using the processor, the highlight clip using the at least one media clip.

2. The method of claim 1, wherein the media content stream comprises a video stream.

3. The method of claim 1, wherein the media content stream comprises an audio stream.

4. The method of claim 1, wherein the social media traffic data comprises microblogging traffic data.

5. The method of claim 1, wherein identifying the at least one highlight portion of the media content stream comprises identifying a corresponding at least one portion of the media content stream associated with a level of social media traffic data exceeding a threshold level.

6. The method of claim 1, wherein identifying the at least one highlight portion of the media content stream comprises identifying a corresponding at least one portion of the media content stream associated with a peak in the social media traffic data.

7. The method of claim 1, further comprising editing the at least one media clip before generating the highlight clip.

8. The method of claim 1, wherein identifying the at least one highlight portion of the media content stream using the social media traffic data comprises detecting keywords associated with the media content stream within the social media traffic data.

9. A system for generating a highlight clip from a media content stream, the system comprising:
a media server accessible over a communication network, the media server including a processor and a memory;
a highlight clip generation module stored in the memory;
the highlight clip generation module, under control of the processor, configured to:
receive social media traffic data related to a playout of the media content stream;
identify at least one highlight portion of the media content stream using the social media traffic data;
select at least one media clip corresponding to the at least one highlight portion from a media content database;
generate the highlight clip using the at least one media clip.

10. The system of claim 9, wherein the media content stream comprises a video stream.

11. The system of claim 9, wherein the media content stream comprises an audio stream.

12. The system of claim 9, wherein the social media traffic data comprises microblogging traffic data.

13. The system of claim 9, wherein identification of the at least one highlight portion of the media content stream comprises identification of a corresponding at least one portion of the media content stream associated with a level of social media traffic data exceeding a threshold level.

14. The system of claim 9, wherein identification of the at least one highlight portion of the media content stream comprises identification of a corresponding at least one portion of the media content stream associated with a peak in the social media traffic data.

15. The system of claim 9, wherein the highlight clip generation module is further configured to edit the at least one media clip before generating the highlight clip.

16. The system of claim 9, wherein identification of the at least one highlight portion of the media content stream using the social media traffic data comprises detection of keywords associated with the media content stream within the social media traffic data.

17. A system for generating a highlight clip from a video stream, the system comprising:
a media server accessible over a communication network, the media server including a processor and a memory;
a highlight clip generation module stored in the memory;
the highlight clip generation module, under control of the processor, configured to:
receive, over the communication network, microblogging traffic data related to a playout of the video stream;
identify at least one highlight portion of the video stream using the microblogging traffic data;
select at least one video clip corresponding to the at least one highlight portion from a media content database;
generate the highlight clip using the at least one video clip.

18. The system of claim 17, wherein identification of the at least one highlight portion of the video stream comprises identification of a corresponding at least one portion of the video stream associated with a level of microblogging traffic data exceeding a threshold level.

19. The system of claim 17, wherein the highlight clip generation module is further configured to edit the at least one video clip before generating the highlight clip.

20. The system of claim 17, wherein identification of the at least one highlight portion of the video stream using the microblogging traffic data comprises detection of keywords associated with the video stream within the microblogging traffic data.
